(19) United States
(12) Patent Application Publication
(10) Pub. No.: US 2013/0032647 A1
(43) Pub. Date: Feb. 7, 2013

(54) OUTLET UNIT WITH SOCKET

(71) Applicants: Huasong Zhou, Xiamen (CN); Haison Peng, Xiamen (CN); Renzhong Li, Xiamen (CN)

(72) Inventors: Huasong Zhou, Xiamen (CN); Haison Peng, Xiamen (CN); Renzhong Li, Xiamen (CN)

(73) Assignees: XIAMEN SOLEX HIGH-TECH INDUSTRIES CO., LTD., Xiamen, Fujian (CN); Huasong Zhou, Xiamen, Fujian (CN)

(21) Appl. No.: 13/509,724

(22) PCT Filed: Nov. 1, 2010
(86) PCT No.: PCT/CN2010/078275

§ 371 Date: May 14, 2012

(30) Foreign Application Priority Data
Nov. 25, 2009 (CN) 200910252612.9
Nov. 25, 2009 (CN) 200920273433.9

(51) Int. Cl. B05B 1/18

(52) U.S. Cl. 239/562; 239/567

(57) ABSTRACT

An outlet unit with socket has a head shower with an essential body and an outlet terminal. The essential body has a top and an under shed and a switch mechanism. The outlet terminal is connected to the under shed and a concave socket is arranged on the essential body. The switch mechanism has an inlet channel that communicates with the top shed and at least one first waterway and one second waterway. The outlet terminal can be rotatably assembled in the under shed of the essential body and can drive the switch mechanism to switch the waterways by rotating. One first or one second waterway can be chosen to communicate with the inlet channel. The first waterway is connected to the outlet terminal. A connector which connects to the second shower through a tube can penetrate the essential body and can communicate with the second waterway.

### FIELD OF THE INVENTION

The present invention relates to a shower device, more particularly to an outlet unit with socket.

### BACKGROUND OF THE INVENTION

At present, the showers have been widely used in daily life, corresponding technical proposals about the outlet unit combining with head shower and handheld shower have been present: a shower comprising a wall shower, a handheld shower and a shower holder has been discloses in the Chinese patent application (CN200820093772.4), wherein, the wall shower is fixedly connected to the wall through bent pipe, a water distributor is arranged in the wall shower, and a socket inserted with the handheld shower is arranged on the shower holder. The American public patent US2006024 2759 relates to a support equipment, wherein, the first shower communicated with the first water outlet is fixed to the wall, a slot inserted with the second shower is arranged on the first shower, the second shower is communicated with the second water outlet through bent tube. The American public patent US20070158460 discloses a shower water distribution equipment which comprises a fixed shower and a handheld shower, wherein, a adjusting knob is arranged on the handle where the handheld shower and the tube are connected.

The technical proposals mentioned above all disclose the outlet unit combining with fixed shower and handheld shower. However, several defects are still present: 1 additional shower holder are need to be arranged in the technical proposals mentioned above with high factory cost, complicated manufacture procedure and increased space occupation; 2 the socket and the body of the shower are not unicase, thus the aesthetic measure and the portable degree are not good enough, the manufacture procedure and the factory cost are affected, and the assembly procedure is been complicated; 3 the use of the socket is affected by the outlet of the shower, and the socket will be spilled by the outlet water; 4 the compatibility of the handheld shower is absent.

### SUMMARY OF THE INVENTION

The object of the present invention is to offer an outlet unit with socket, which overcome the technical matter proposed in the prior art.

The technical proposal to solve the technical matter in the present invention is:

An outlet unit with socket, it comprises a head shower which comprises an essential body and an outlet terminal, the essential body is provided with a top shed and a under shed, the outlet terminal is assembled to the under shed, a concave socket is arranged on the essential body.

In a preferred embodiment, the socket is concavely arranged at the waist of the essential body.

In a preferred embodiment, the socket and the essential body are unicase

In a preferred embodiment, the socket comprises a hole and a pair of lugs arranged at both sides of the hole; the shape of the hole is adaptive to the shape of the trumpet shaped joint of the handheld shower.; the axis of the hole is basically parallel to the end face of the under shed of the essential body.

In a preferred embodiment, a switch mechanism is arranged in the essential body, the switch mechanism is provided with a inlet channel that is communicated with the top shed, at least one first waterway and one second waterway, the outlet terminal can be rotatably assembled in the under shed of the essential body and can drive the switch mechanism to switch the waterways by rotating, and then the first waterway or the second waterway can be chosen to be communicated with the inlet channel;

The first waterway is connected to the outlet terminal;

A connector that can penetrate the essential body from inside to outside and be communicated with the second waterway is arranged on the essential body, the connector is connected to the second shower through a tube.

In a preferred embodiment, the socket is adaptive to the second shower, and the second shower can be inserted in the socket.

In a preferred embodiment, the outlet terminal is provided with a plurality of outlet functions, the amount of the first waterways of the switch mechanism is equal to the amount of the outlet functions, and the first waterways are exactly-correspondingly communicated with the outlet functions.

In a preferred embodiment, the switch mechanism comprises an inlet body that is hermetically fixed in the essential body and is provided with at least one inlet channel penetrate itself up and down;

And a water division body that is rotatably and hermetically arranged in the essential body, wherein, the upper surface of the water division body is hermetically connected to the lower surface of the inlet body, and at least one first waterway and one second waterway are provided, and the water division body is fixedly connected to the outlet terminal, so that the water division body can rotate with respect to the inlet body driven by the rotation of the outlet terminal, and then one first waterway or one second waterway is chosen to be communicated with the inlet channel by the waterways switch.

In a preferred embodiment, the first waterways are provided with a first entrance arranged on the upper end surface of the water division body and a first exit arranged on the lower end surface of the water division body and communicated with the outlet terminal;

The second waterway is provided with a second entrance arranged on the upper end surface of the water division body and a second exit arranged on the external revolving surface of the water division body, and the second exit is just aligned to the connector when the second entrance is aligned to the inlet channel.

In a preferred embodiment, the first entrance and the second entrance are distributed along the arc whose the centre is at the rotation axis, the radius of the arc is adaptive to the distance between the under shed of the inlet channel and the rotation axis.

The invention has the advantageous that: 1 the shower holder is left out in the outlet equipment; 2 the socket is directly formed on the shower, the manufacturing procedure is handily, the space occupation is small, and the assembly is simplified; 3 the outlet area and the traditional outlet face cover are not affected by the combination of the fixed shower and the handheld shower; 4 the socket arranged at the waist of the shower cannot be affected by the head shower, and water is not spilled to the users; 5 as needed, the socket is inserted not only by the handheld shower, but also by other groceries, such as towels or bulbs; 6 the hole of the socket is designed to be trumpet shaped; 7 the distribute adjusting knob of the outlet equipment is arranged on the outlet face cover of the fixed shower, different outlet functions of the fixed shower and the waterways of the fixed shower and the handheld shower are switched and chosen by slightly rotating the adjusting knob, the switching is convenient and fast, the switches are all controlled by the rotation of the outlet terminal, and the method is designed humanly; 8 the socket is concavely arranged at the waist of the essential body directly, thus the outlet face and the outlet structure of the essential body are not changed by the addition of the socket; the product is aesthetic and compact, the user's practical requirements are well satisfied, and the shower effects are more diverse and funny.

### BRIEF DESCRIPTION OF THE DRAWINGS

FIG. 1 shows the three-dimensional diagram of the outlet unit with socket offered by the preferred embodiment in the present invention, the water does not comes out of the outlet unit at the moment.

FIG. 2 shows the exploded view of the head shower of the outlet unit with socket offered by the preferred embodiment in the present invention.

FIG. 3 shows the sectional view of the head shower of the outlet unit with socket offered by the preferred embodiment in the present invention.

FIG. 4 shows the sectional view of the head shower of the outlet unit with socket offered by the preferred embodiment in the present invention, the sparking water comes out of the head shower at the moment.

FIG. 5 shows the cross section view of the water division body offered by the preferred embodiment in the present invention, the sparking water comes out of the head shower at the moment.

FIG. 6 shows the three-dimensional diagram of the outlet unit with socket offered by the preferred embodiment in the present invention, the sparking water comes out of the head shower at the moment.

FIG. 7 shows the sectional view of the head shower of the outlet unit with socket offered by the preferred embodiment in the present invention, the massage water comes out of the head shower at the moment.

FIG. 8 shows the cross section view of the water division body offered by the preferred embodiment in the present invention, the massage water comes out of the head shower at the moment.

FIG. 9 shows the three-dimensional diagram of the outlet unit with socket offered by the preferred embodiment in the present invention, the massage water comes out of the head shower at the moment.

FIG. 10 shows the sectional view of the head shower of the outlet unit with socket offered by the preferred embodiment in the present invention, the shower water comes out of the head shower at the moment.

FIG. 11 shows the cross section view of the water division body offered by the preferred embodiment in the present invention, the shower water comes out of the head shower at the moment.

FIG. 12 shows the three-dimensional diagram of the outlet unit with socket offered by the preferred embodiment in the present invention, the shower water comes out of the head shower at the moment.

FIG. 13 shows the sectional view of the head shower of the outlet unit with socket offered by the preferred embodiment in the present invention, the second waterway is communicated at the moment.

FIG. 14 shows the cross section view of the water division body offered by the preferred embodiment in the present invention, the water comes out of the handheld shower at the moment.

FIG. 15 shows the three-dimensional diagram of the outlet unit with socket offered by the preferred embodiment in the present invention, the water comes out of the handheld shower at the moment.

FIG. 16 shows the three-dimensional diagram of the outlet unit with socket offered by another embodiment in the present invention, the water comes out of the handheld shower at the moment.

FIG. 17 shows the three-dimensional diagram of the outlet unit with socket offered by one more embodiment in the present invention, the water comes out of the handheld shower at the moment.

### REFERENCE SIGNS

Head shower-100; essential body-100; top shed-111; under shed-112; socket-140; outlet terminal-120; knob-121; connector-130;

Switch mechanism-200; inlet body-210; inlet channel-211; water division body-220; first waterway-221, 222, 223; first entrance-2211, 2221, 2231; first exit-2212, 2222, 2232; second waterway-224; second entrance-2241; second exit-2242; leather cup-225; spring-226; location pin-227;

Handheld shower-300; trumpet shaped joint-310; tube-400; ball joint component-500

### DESCRIPTION OF THE PREFERRED EMBODIMENTS

With the following description of the drawings and specific embodiments, the invention shall be further described in details.

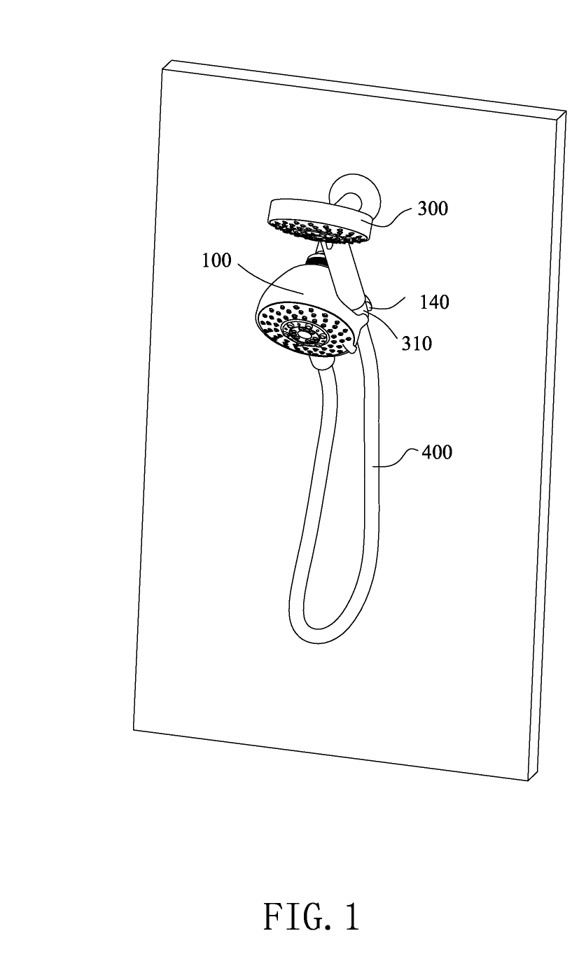

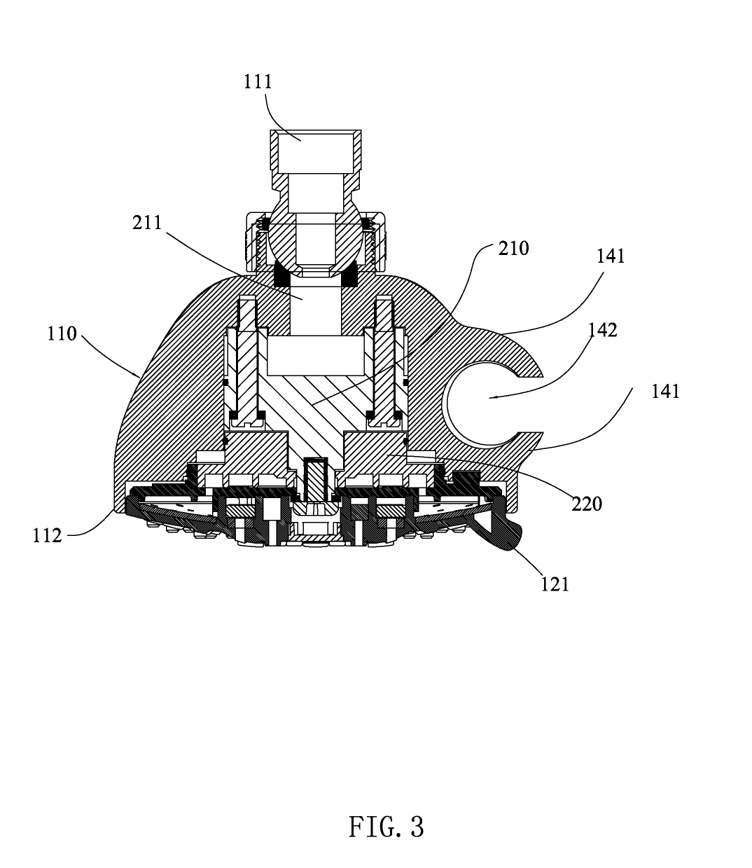

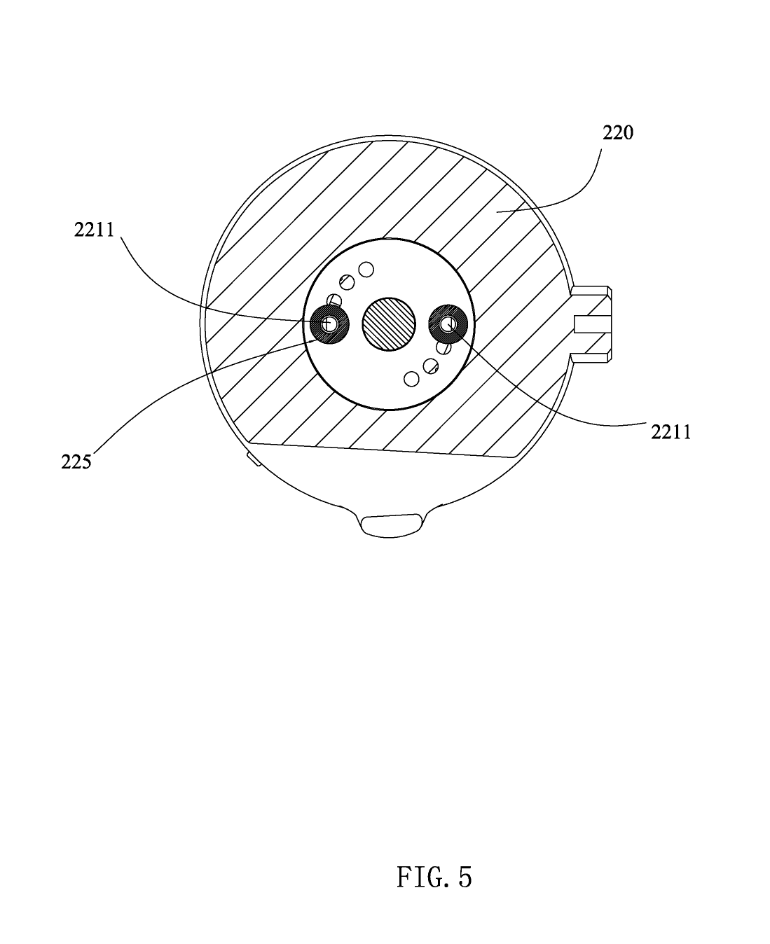

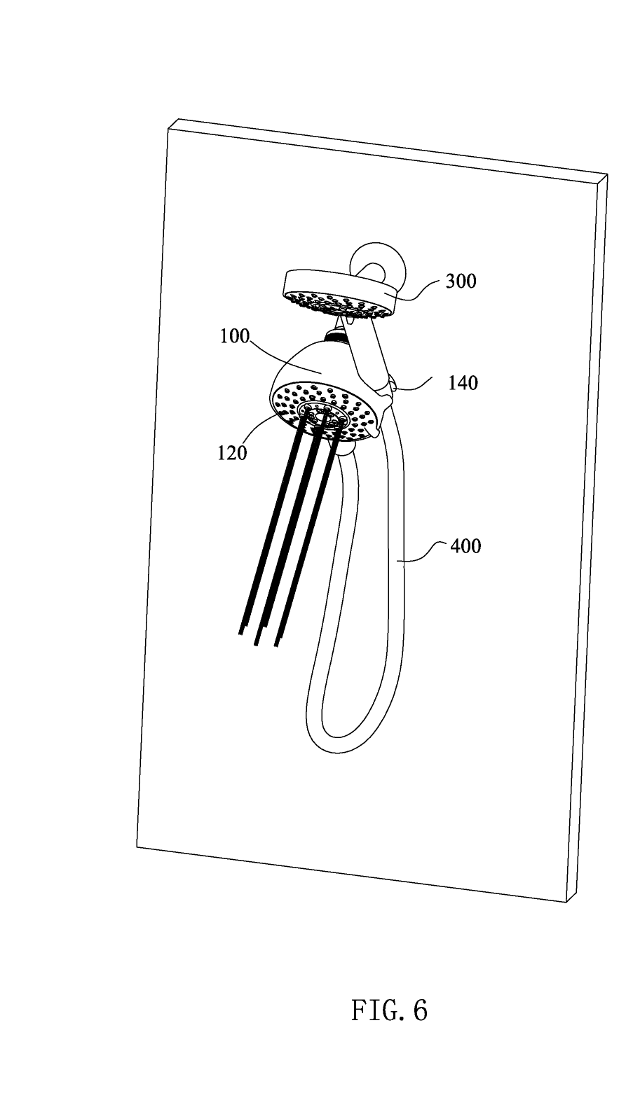

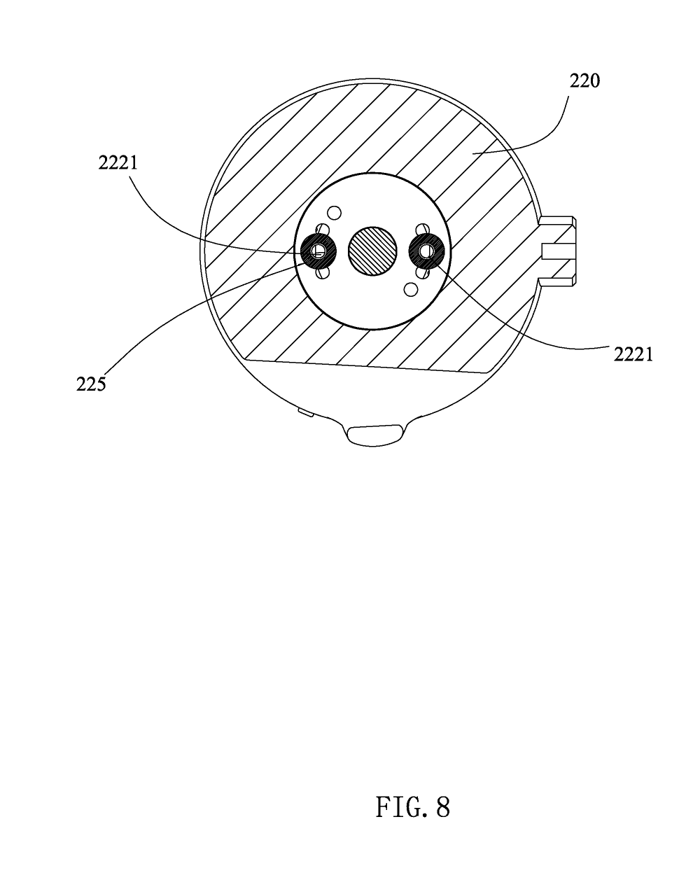

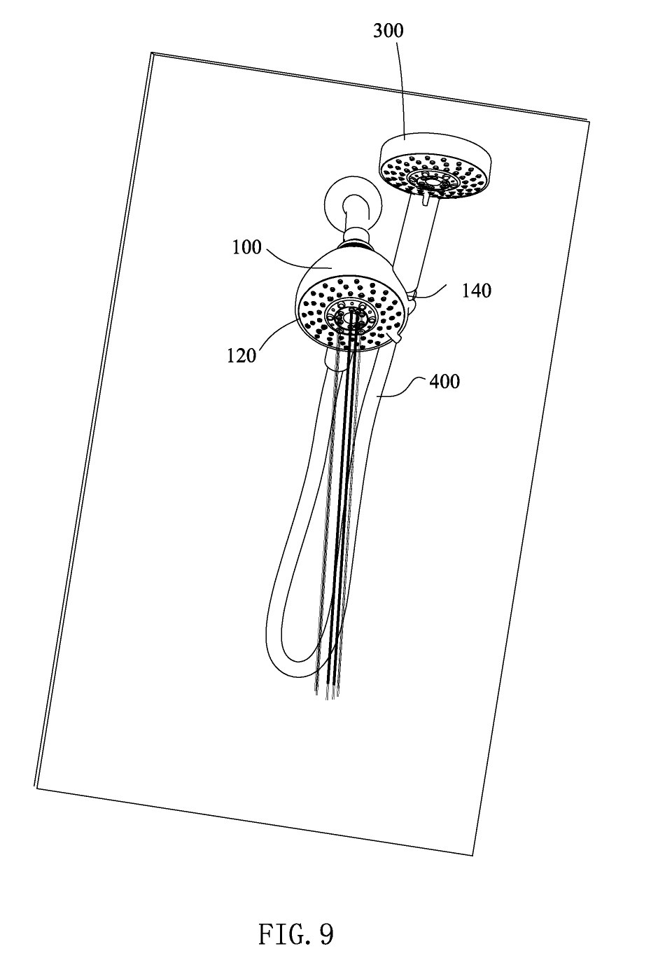

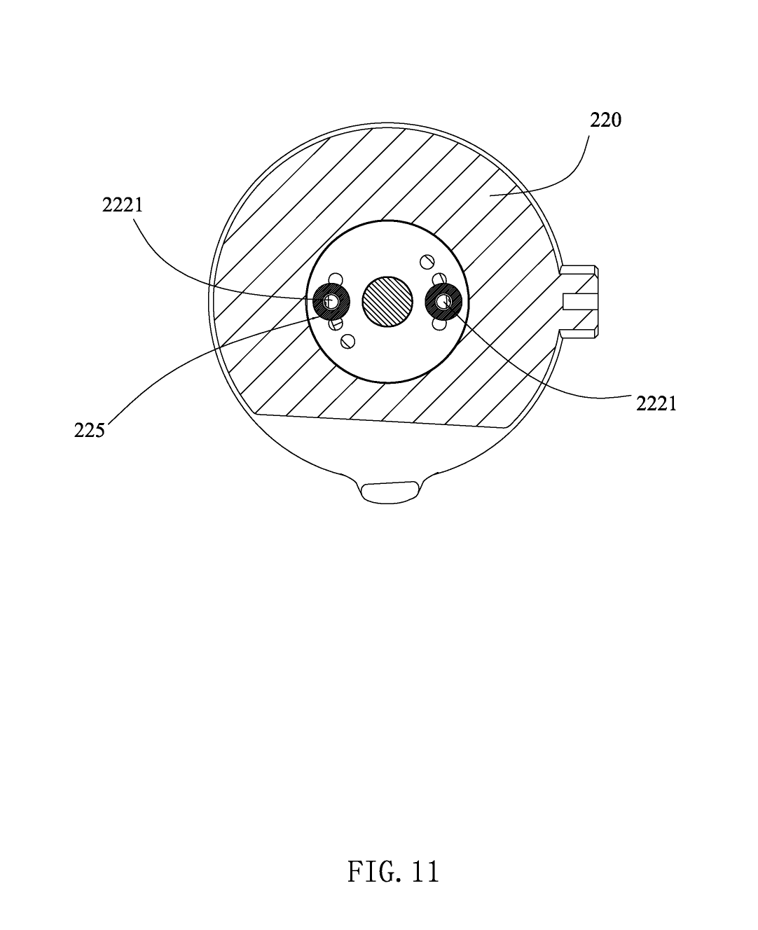

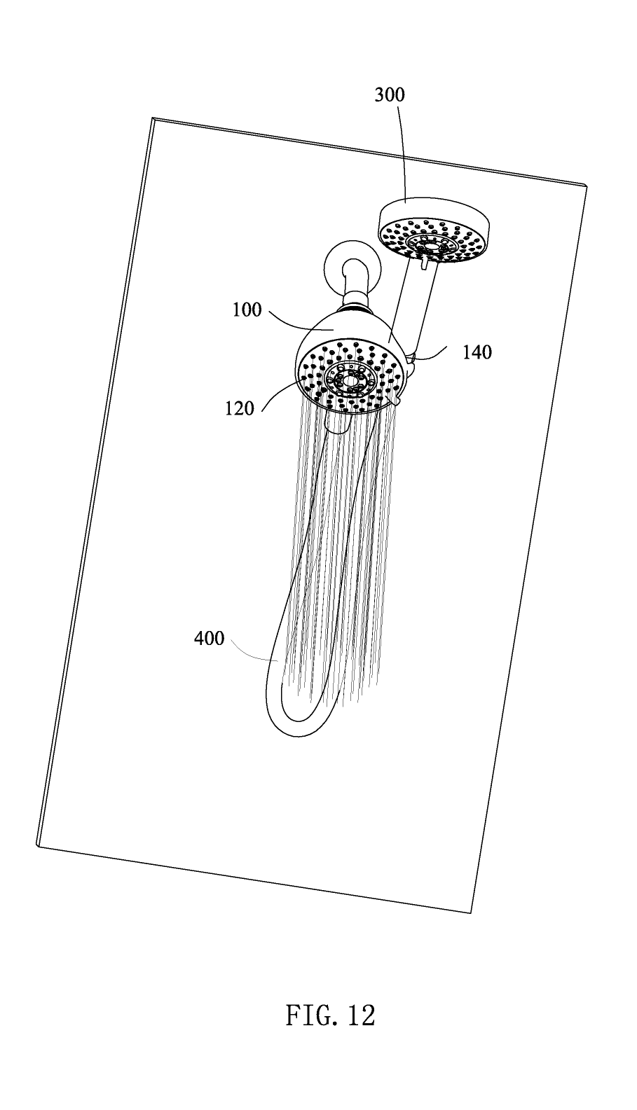

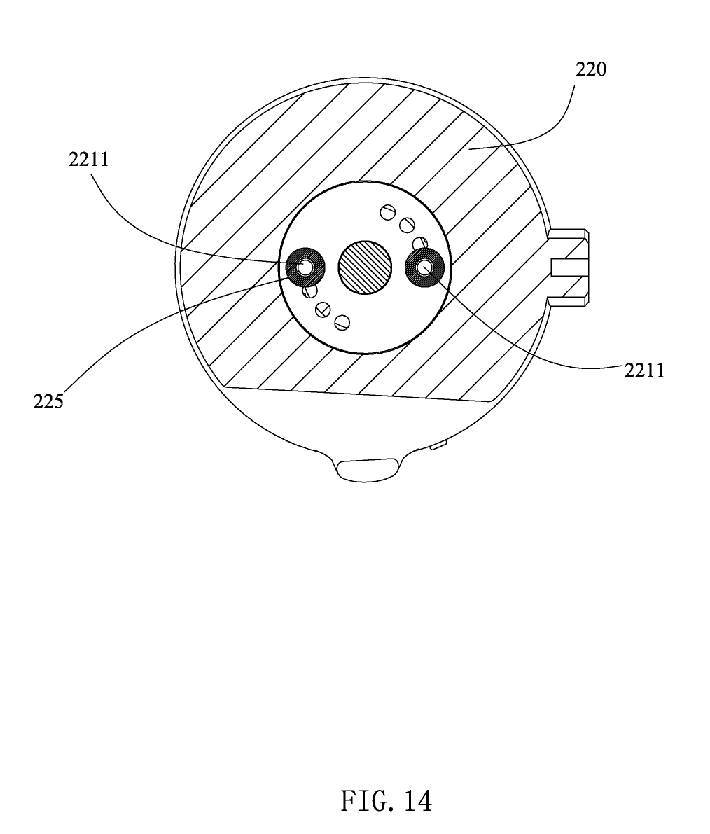

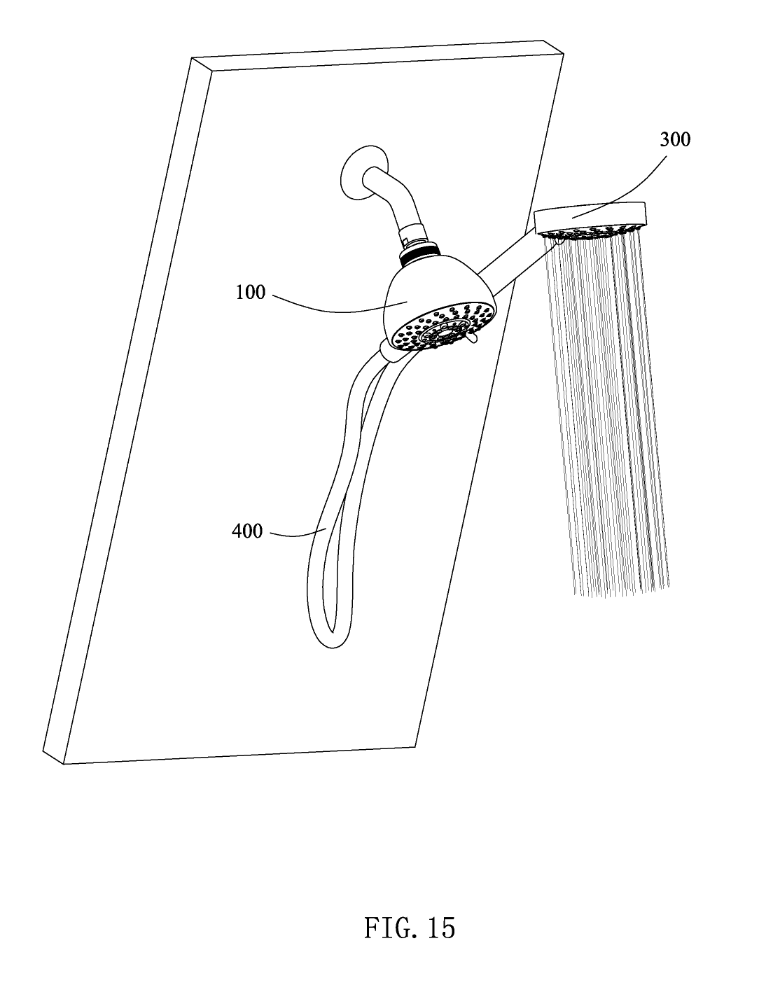

According to FIG. 1 to FIG. 15, the outlet unit with socket offered by the preferred embodiments in the present invention is present.

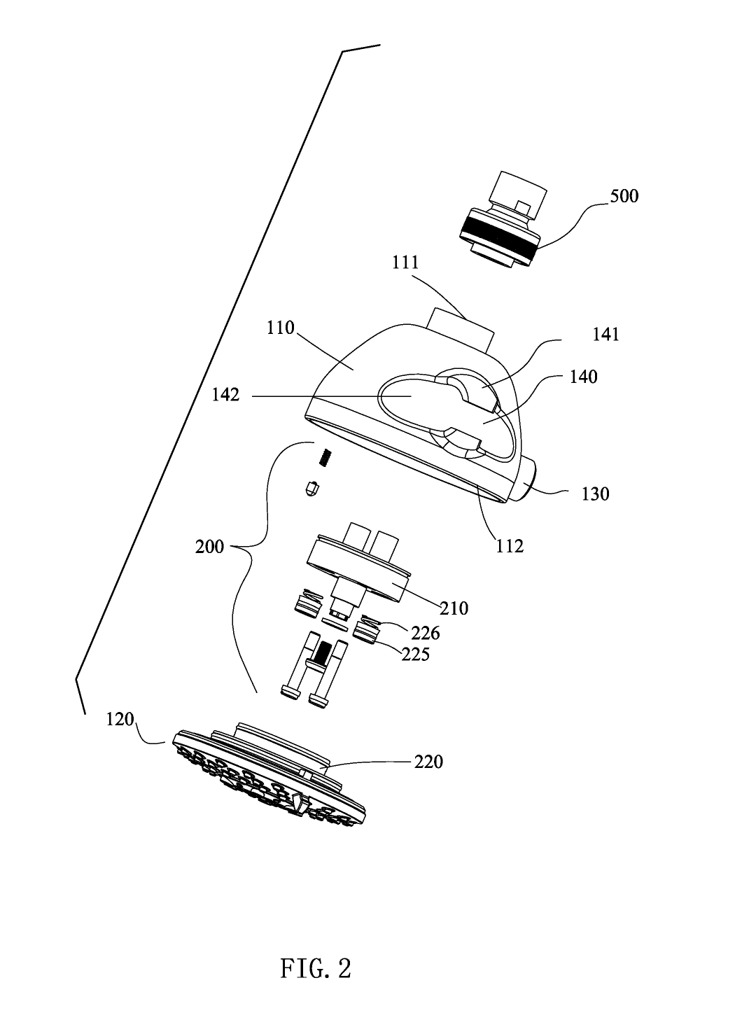

As shown in FIG. 1 and FIG. 2, the outlet unit with socket comprises a head shower 100, a switch mechanism 200, a handheld shower 300, a tube 400 and a ball joint component 500.

The head shower 100 comprises an essential body 110, an outlet terminal 120 and a connector 130, the essential body is provided with a top shed 111 and a under shed 112, a socket 140 is concavely arranged at the waist of the essential body, the socket 140 comprises a trumpet shaped hole 142 and a pair of lugs 141 arranged at both sides of the hole; the axis of the hole 142 is basically parallel to the end face of the under shed 112 of the essential body 110, and the hole 142 is directed concavely arranged at the waist of the essential body; the outlet terminal 120 comprises an outlet front cover with a plurality of outlet functions, which is hermetically arranged under the under shed of the essential body, and a knob 121 is arranged on the outlet front cover to adjust the outlet functions; a connector that penetrates the essential body 100 from inside to outside is arranged on the essential body 110.

The switch mechanism 200 that is hermetically assembled in the essential body 110 comprises an inlet body that is fixed in the essential body 110 and a water division body 220 that can be rotatably assembled in the essential body 110. The inlet body 210 comprises a inlet channel 211 which is communicated with the top shed 111, the upper surface of the water division body is hermetically connected to the lower surface of the inlet body 210, the water division body 220 at least comprises a first waterways 221, 222, 223 and a second waterway 224, thus the water division body 220 can rotate with respect to the inlet body 210 driven by the rotation of the outlet terminal 120, and one first waterway or a second waterway can be chosen to communicated with the inlet channel 211 through the waterway switch. The amount of the first waterway is equal to the amount of the outlet functions of the outlet terminal 120, and the first waterway comprises two symmetrically arranged first entrances and two corresponding first exits, wherein, these first entrances are arranged on the upper end surface of the water division body 220, and the second exit is arranged on the lower end surface of the water division body 220 and can be alternatively communicated with the corresponding outlet function of the outlet terminal. The connector 130 is communicated with the second waterway 224, the second waterway comprises a second entrance 2241 arranged on the upper end surface of the water division body and a second exit 2242 arranged on the external revolving surface of the water division body. The first entrances 2211, 2221, 2231 and the second entrance 2241 are distributed along the arc whose the centre is at the rotation axis, the radius of the arc is adaptive to the distance between the under shed of the inlet channel 211 and the rotation axis. A leather cup 225 and a spring 226 adaptive to the leather cup 225 are assembled in the lower port of the inlet channel 211 of the water division body; additionally, a location pin 227 is arranged in the groove of the end face of the essential body 110, and resists to the outlet terminal 120.

The handheld shower 300 is inserted in the socket 140 and is communicated with the connector 130 through the tube 400, water comes out of the second shower when the second waterway 224 is communicated with the inlet channel 211. The second shower in the present embodiment is a handheld shower, and the trumpet shaped joint 310 is general part that is adaptive to the hole 142 of the socket 140.

The head shower 100 is connected to the wall through the ball joint component 500.

The switching principle of the outlet functions of the outlet equipment is:

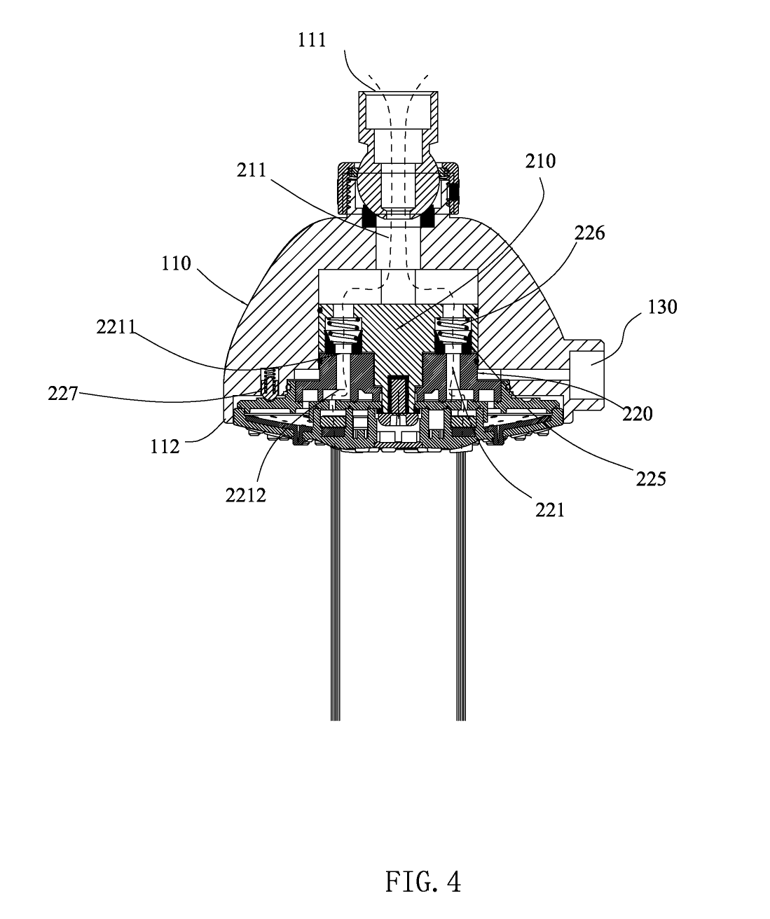

As shown in FIG. 4, 5 and 6, the abridged general view of the head shower 100 of the outlet equipment is present, and the sparking water comes out of the head shower 100 at the moment. By turning the knob 121the water division body 200 rotate with respect to the inlet body 210 driven by the rotation of the outlet terminal 120, the first entrance 2211 of a first waterway 221 is communicated with the inlet channel 211 at the moment, the spring 226 adaptive to the leather cup 225 resist and is aligned with the first entrance 211, other entrances of the first waterway and the second entrance of the second watery are sealed at the moment, and by the action of the location pin 227, the outlet terminal 120 stops rotating, water comes out of the outlet front cover along the first waterway 221, and the sparking water outlet effect is present.

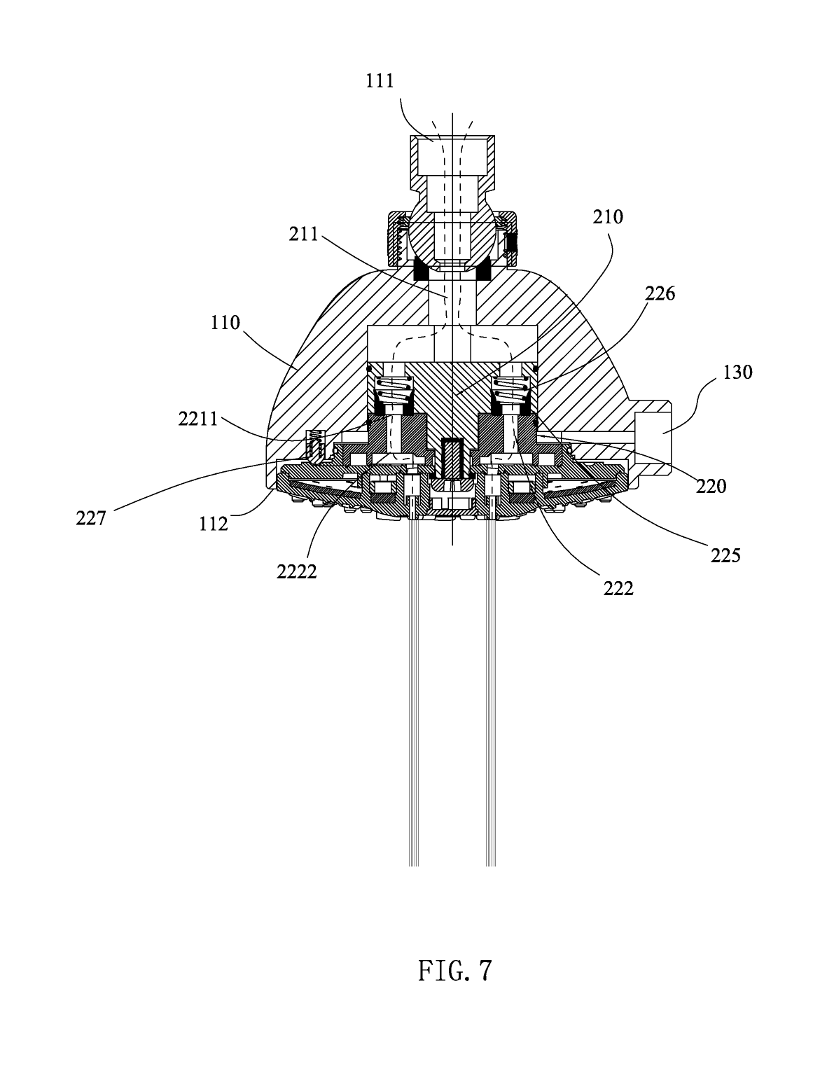

As shown in FIGS. 7, 8 and 9, the abridged general view of the head shower 100 of the outlet equipment is present, and the massage water comes out of the head shower 100 at the moment. Similarly, by turning the knob 121, the first waterway 222 is communicated with the inlet channel 211, other entrances of the first waterway and the second entrance of the second watery are sealed, water flows along the first waterway 222, and the massage water outlet effect is present.

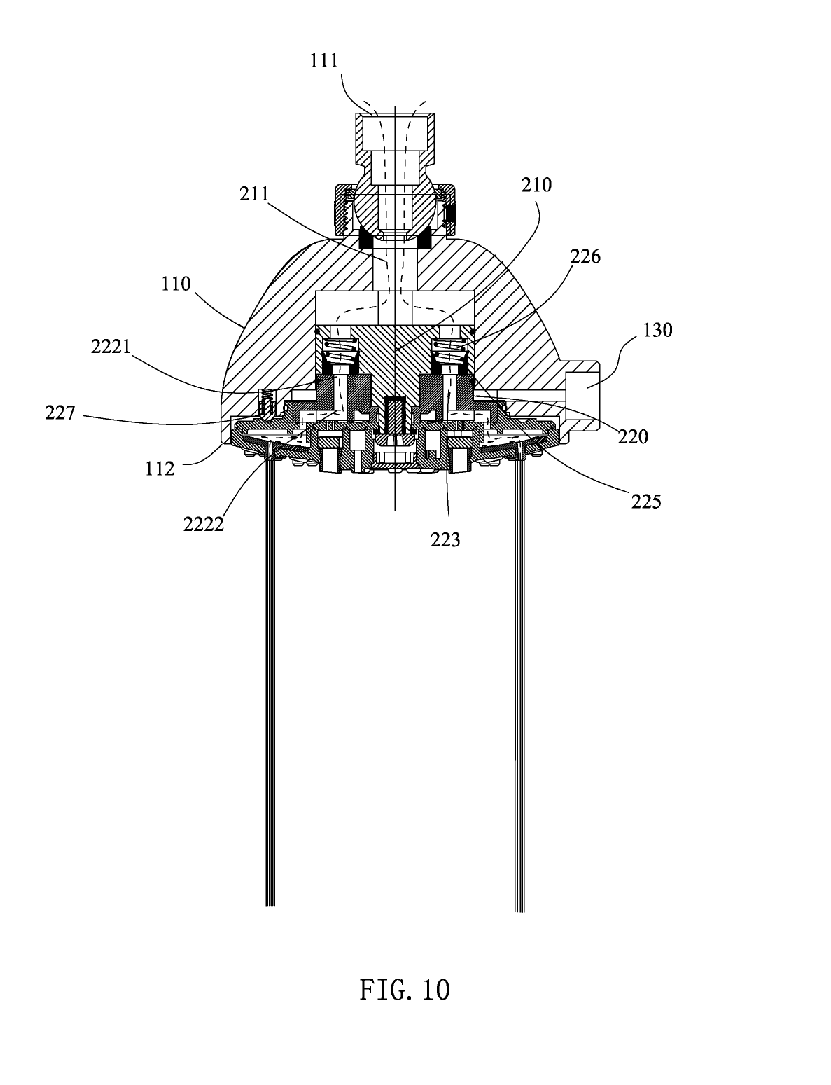

As shown in FIGS. 10, 11 and 12, the abridged general view of the head shower 100 is present, and the shower water comes out of the head shower 100 at the moment. Similarly, by turning the knob 121, the outlet terminal 120 rotates again, the first waterway 223 is communicated with the inlet channel 211 at the moment, other entrances are sealed, water flows into the first entrance 2231 along the first waterway 223 and enters the outlet terminal through the corresponding second exit 2232, and finally water comes out of the outlet front cover, and the shower water comes out of the head shower.

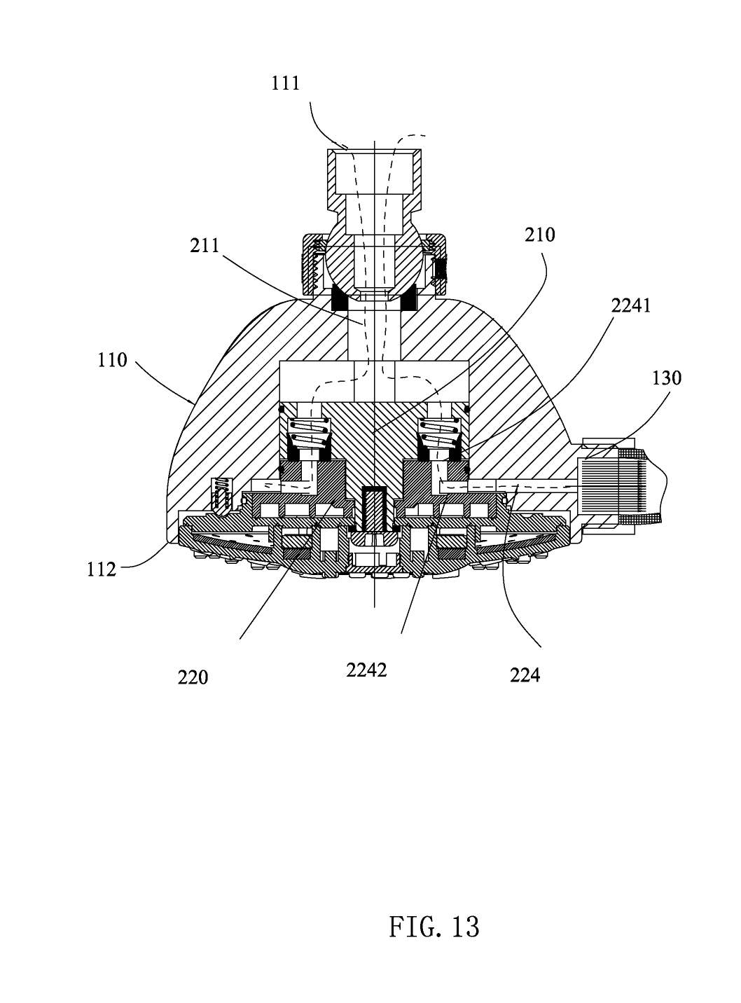

As shown in FIGS. 13, 14 and 15, he abridged general view of the handheld shower 300 is present, water comes out of the handheld shower 300 at the moment. By turning the knob 121 again, the water division body 220 rotates with respect to the inlet body 210 driven by the rotation of the outlet terminal 120, the entrances 221, 222 and 223 of the first waterway and the inlet channel 211 are sealed, and the second waterway 224 is communicated with the inlet channel 211, the current enters the second waterway 224 through the second entrance 2241, and then enters the connector 130 aligned with the second exit 2242, and then enters the handheld shower 300 through the tube 400, and water comes out of the handheld shower 300 at the moment.

As needed, the socket 140 of the essential body 110 can not only be inserted with the handheld shower, but also be multi-function holder for groceries such as towel, or be bulb mounting base.

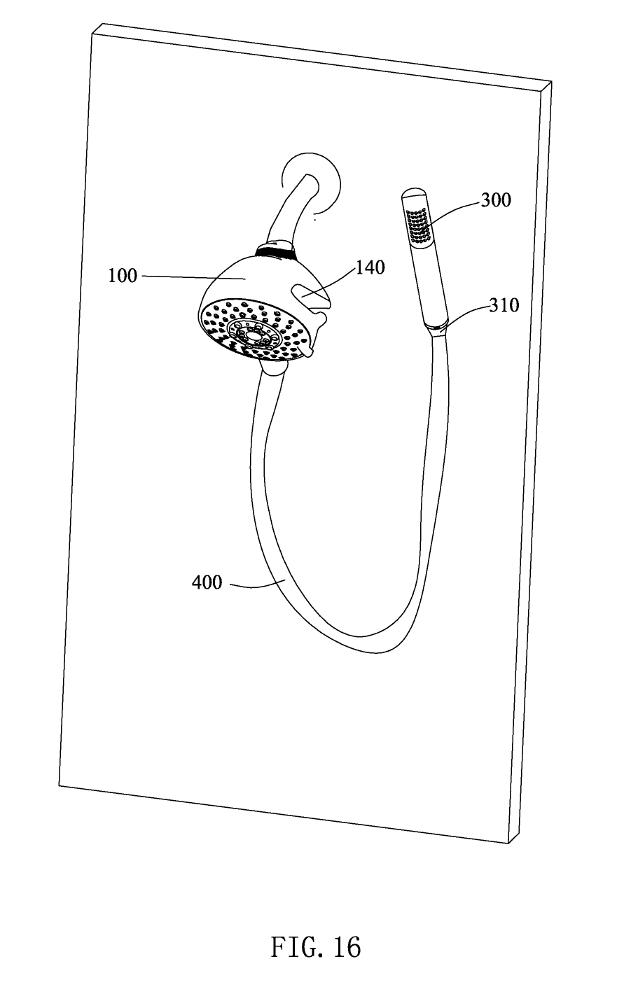

FIG. 16 shows another embodiment of the present invention, wherein, the handheld shower 300 is cylindrical shower, the joint of the shower is standard trumpet shaped joint 310, thus the handheld shower 300 can be advantageously inserted in the hole 142 of the socket 140.

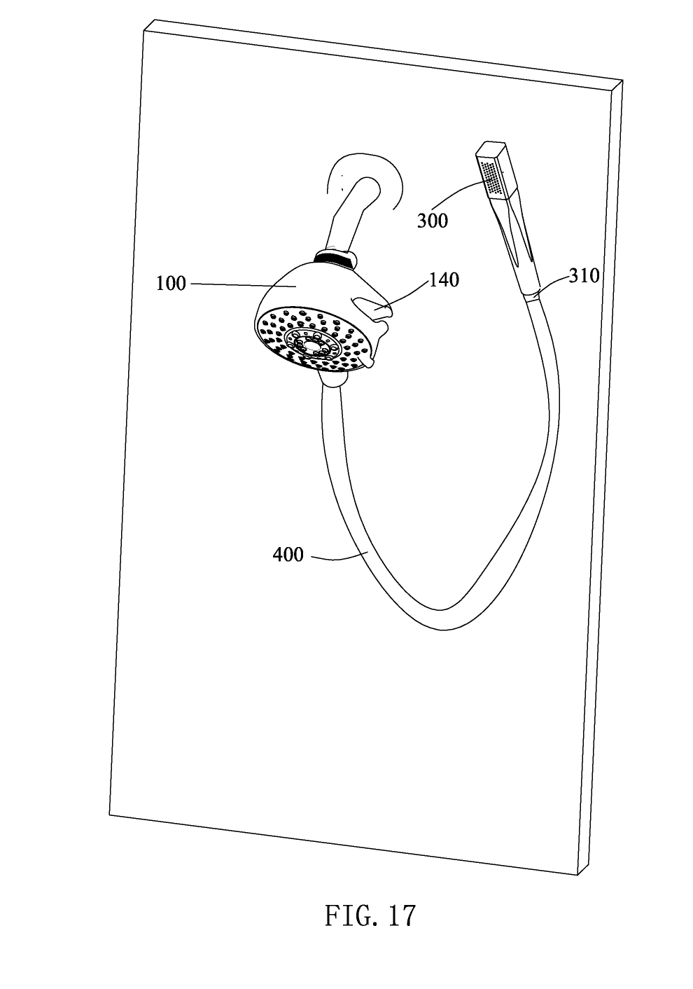

FIG. 17 shows one more embodiment of the present invention, wherein, the handheld shower 300 is square shower, the joint of the shower is standard trumpet shaped joint 310, thus the handheld shower 300 can be advantageously inserted in the hole 142 of the socket 140.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

### INDUSTRIAL APPLICABILITY

The outlet unit with socket in the present invention comprises a head shower and a handheld shower, a concave socket in which the handheld shower can be inserted is arranged in the essential body of the head shower. The present invention is artistic and compact, the user's practical requirements are well satisfied, and the shower effects are diverse, and the industrial applicability is good.

1. Outlet unit with socket, wherein, it comprises a head shower which comprises an essential body and an outlet terminal, the essential body is provided with a top shed and a under shed, the outlet terminal is assembled to the under shed, a concave socket is arranged on the essential body.

2. The outlet unit with socket according to claim 1, wherein, the socket comprises a hole and a pair of lugs arranged at both sides of the hole; the shape of the hole is adaptive to the shape of the trumpet shaped joint of the handheld shower.

3. The outlet unit with socket according to claim 1, wherein, the socket is concavely arranged at the waist of the essential body.

4. The outlet unit with socket according to claim 3, wherein, the socket and the essential body are unicase, the axis of the hole is basically parallel to the end face of the under shed of the essential body.

5. The outlet unit with socket according to claim 2, wherein, a switch mechanism is arranged in the essential body, the switch mechanism is provided with a inlet channel that is communicated with the top shed, at least one first waterway and one second waterway, the outlet terminal can be rotatably assembled in the under shed of the essential body and can drive the switch mechanism to switch the waterways by rotating, and then the first waterway or the second waterway can be chosen to be communicated with the inlet channel;
The first waterway is connected to the outlet terminal;
A connector that can penetrate the essential body from inside to outside and be communicated with the second waterway is arranged on the essential body, the connector is connected to the second shower through a tube.

6. The outlet unit with socket according to claim 5, wherein, the socket is adaptive to the second shower, and the second shower can be inserted in the socket.

7. The outlet unit with socket according to claim 6, wherein, the outlet terminal is provided with a plurality of outlet functions, the amount of the first waterways of the switch mechanism is equal to the amount of the outlet functions, and the first waterways are exactly-correspondingly communicated with the outlet functions.

8. The outlet unit with socket according to claim 7, wherein, the switch mechanism comprises an inlet body that is hermetically fixed in the essential body and is provided with at least one inlet channel penetrate itself up and down;
And a water division body that is rotatably and hermetically arranged in the essential body, wherein, the upper surface of the water division body is hermetically connected to the lower surface of the inlet body, and at least one first waterway and one second waterway are provided, and the water division body is fixedly connected to the outlet terminal, so that the water division body can rotate with respect to the inlet body driven by the rotation of the outlet terminal, and then one first waterway or one second waterway is chosen to be communicated with the inlet channel by the waterways switch.

9. The outlet unit with socket according to claim 8, wherein, the first waterways are provided with a first entrance arranged on the upper end surface of the water division body and a first exit arranged on the lower end surface of the water division body and communicated with the outlet terminal;
The second waterway is provided with a second entrance arranged on the upper end surface of the water division body and a second exit arranged on the external revolving surface of the water division body, and the second exit is just aligned to the connector when the second entrance is aligned to the inlet channel.

10. The outlet unit with socket according to claim 9, wherein, the first entrance and the second entrance are distributed along the arc whose the centre is at the rotation axis, the radius of the arc is adaptive to the distance between the under shed of the inlet channel and the rotation axis.

11. The outlet unit with socket according to claim 4, wherein, a switch mechanism is arranged in the essential body, the switch mechanism is provided with a inlet channel that is communicated with the top shed, at least one first waterway and one second waterway, the outlet terminal can be rotatably assembled in the under shed of the essential body and can drive the switch mechanism to switch the waterways by rotating, and then the first waterway or the second waterway can be chosen to be communicated with the inlet channel;

12. The outlet unit with socket according to claim 11, wherein, the socket is adaptive to the second shower, and the second shower can be inserted in the socket.

13. The outlet unit with socket according to claim 12, wherein, the outlet terminal is provided with a plurality of outlet functions, the amount of the first waterways of the switch mechanism is equal to the amount of the outlet functions, and the first waterways are exactly-correspondingly communicated with the outlet functions.

14. The outlet unit with socket according to claim 13, wherein, the switch mechanism comprises an inlet body that is hermetically fixed in the essential body and is provided with at least one inlet channel penetrate itself up and down;
And a water division body that is rotatably and hermetically arranged in the essential body, wherein, the upper surface of the water division body is hermetically connected to the lower surface of the inlet body, and at least one first waterway and one second waterway are provided, and the water division body is fixedly connected to the outlet terminal, so that the water division body can rotate with respect to the inlet body driven by the rotation of the outlet terminal, and then one first waterway or one second waterway is chosen to be communicated with the inlet channel by the waterways switch.

15. The outlet unit with socket according to claim 14, wherein, the first waterways are provided with a first entrance arranged on the upper end surface of the water division body and a first exit arranged on the lower end surface of the water division body and communicated with the outlet terminal;
The second waterway is provided with a second entrance arranged on the upper end surface of the water division body and a second exit arranged on the external revolving surface of the water division body, and the second exit is just aligned to the connector when the second entrance is aligned to the inlet channel.

16. The outlet unit with socket according to claim 15, wherein, the first entrance and the second entrance are distributed along the arc whose the centre is at the rotation axis, the radius of the arc is adaptive to the distance between the under shed of the inlet channel and the rotation axis.
